(19) United States
(12) Patent Application Publication
(10) Pub. No.: US 2003/0102412 A1
(43) Pub. Date: Jun. 5, 2003

(54) Suspension device for elongated objects

(76) Inventor: Stefan Miescher, (US)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/298,751

(22) Filed: Nov. 18, 2002

(30) Foreign Application Priority Data
Nov. 30, 2001 (DE) 10159012.1

(51) Int. Cl. F16L 3/00

(52) U.S. Cl. 248/62; 248/68.1; 248/71

(57) ABSTRACT

A fastening device for elongate objects such as pipes, cables or the like comprising a fastening member (1), a hook-shaped receiving member (2) connected therewith for holding the objects and a bridging member (3) pivotingly connected with one end of the fastening member (1). The bridging member (3) is connectable to the free end (6) of the receiving member (2) by a latch (5). The bridging member (3) comprises an at least partially resiliently configured locking zone (4) to provide a latch (5) that can easily be manually set.

### BACKGROUND OF THE INVENTION

The invention relates to a suspension device for elongated objects, such as pipes, cables or the like, comprising a fastening member, a hook-like receiving member connected thereto for holding the objects and a bridging member pivotally connected at one end that is connectable with the free end of the receiving member by means of a latch.

Fastening devices of this type are used to hang pipes or cables. The fastening assembly made of strip material comprises a fastening element and a receiving member. The receiving member is essentially hook-like to receive the objects to be suspended, which are compressed in the receiving member by the force of weight. The fastening member is used for fastening the fastening assembly to a ceiling. Dowels, for example, can be used as the fastening means to fasten the fastening member to the ceiling through a through hole. Another example of a fastening possibility is that an explosive powder-driven setting machine can be used to set a nail through the fastening member into the ceiling.

U.S. Pat. No. 3,218,012 discloses a fastening device comprising a fastening member, a hook-like configured receiving member connected thereto for holding elongate objects and a bridging member pivotally connected to one end of the fastening member. The bridging member can be connected to the free end of the receiving member by a locking bridge member to prevent the object held in the receiving member from slipping out. The locking member comprises a catch member arranged at the free end of the receiving member and bent by the same and a T-shaped engaging member arranged at the free end of the bridging member. The bridging member extending away from the fastening member is provided with a longitudinal slot openly configured towards the free end for receiving the engaging member. In a holding position the engaging member lockingly engages the slot of the catch member. For actuating the locking member the receiving member is snapped thereinto.

The drawback of the known solution is that actuation of the locking member is unwieldy. Further, loosening of the locking member with the object lying in the receiving member is extremely difficult if not impossible, because the object complicates snapping the receiving member together. If the object is almost completely in the internal contour of the receiving member, then an opening of the locking member is nearly impossible.

### SUMMARY OF THE INVENTION

The object of the present invention is to provide a fastening device that is inexpensive to manufacture comprising a simple and problem-free hook-shaped receiving member that can be latched without complications and is manageable.

The object is achieved according to the invention in that the bridging member comprises a deflected locking zone that is configured at least partially resiliently.

The configuration of the bridging member, according to the invention, enables the user of the fastening device to detachably connect the bridging member using the locking member without great force with the free end of the receiving member. The resiliently configured locking zone provides for simple actuation of the locking member even when the object to be fastened is resting almost completely in the inner contour of the receiving member.

Preferably, the locking zone is so deflected, that when it is in the holding position of the locking member it at least partially overlaps the receiving member so that a flat surface contact zone is established for locking to the receiving member.

The locking zone is deflected essentially at a right angle from the rest of the bridging member, so that, on the one hand, an uncomplicated alignment of the locking zone of the bridging member with the free end of the receiving member is assured and, on the other hand, the contact between the two parts is as flat as possible.

To assure inexpensive manufacturing of the fastening device the locking member is configured as a snap-closure. In particular, the snap closure comprises, at one point, at least one recess and, at another point, at least one engaging member to engage the recess. Due to the fact that the locking zone of the bridging member is at least partially resiliently configured, the two members of the locking member can be moved relative to each other without great force and the locking member can be opened and closed.

The engaging member is preferably configured as a tab that is deflected relative to the rest of the locking zone to assure inexpensive manufacturing of the locking member. In a further embodiment the engaging member is configured as a stamped part.

To provide the user with a manageable mode of actuation for the locking member, the bridging member preferably comprises an actuation member.

The actuation member is arranged preferably at the free end of the bridging member to assure the most compact construction of the fastening device.

Preferably, the actuation member is deflected away from the bridging member and, in the holding position, extends away from the receiving member so that the user is provided with convenient access to the actuation member.

Preferably, the receiving member has a U-shaped cross-section, whereby the two legs enclose an angle of from 10° to 25°.

Preferably, the locking member of the bridging member, in the holding position, is in contact with the external contour of the free end of the receiving member.

### BRIEF DESCRIPTION OF THE DRAWINGS

The invention will be more completely described below using an exemplary embodiment and referring to the Figures, wherein:

FIG. 1 represents a perspective view of the fastening device according to the invention with a pre-mounted bridging member;

FIG. 2 represents a perspective view of the fastening device shown in FIG. 1 in the release position;

FIG. 3 represents a perspective view of the fastening device shown in FIG. 2 in the holding position;

FIG. 4 represents a side view of the fastening device shown in FIG. 2 in the release position;

FIG. 5a represents a side view of the fastening device shown in FIG. 3 in the holding position;

FIG. 5b represents an enlarged cut-out in the area Va from FIG. 5.

### DETAILED DESCRIPTION OF THE INVENTION

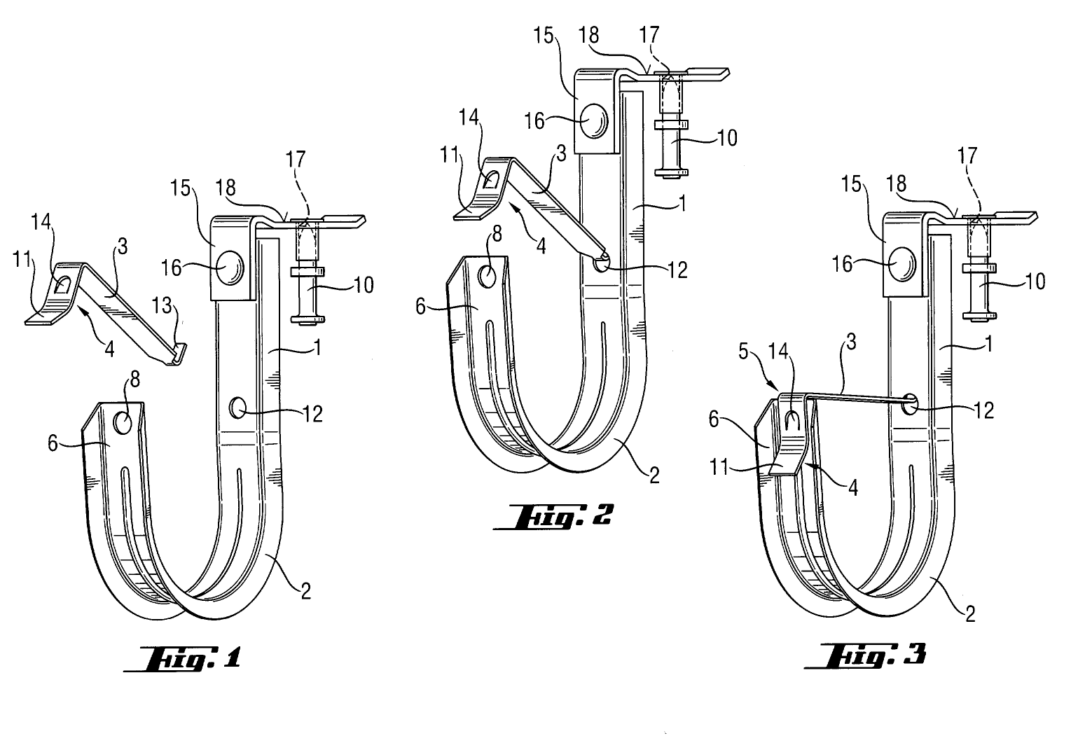

FIGS. 1 to 5 represent a fastening device, in accordance with the invention, comprising a fastening member 1, a hook-shaped receiving member 2 connected therewith for holding elongate objects (not shown) and a bridging member 3 connected with the fastening member 1 at one end.

The bridging member 3 is connectable by a latch 5 with the free end 6 of the receiving member 2. The bridging member 3 comprises a resiliently configured locking zone 4, which is deflected so that, in a holding position of the latch 5, as represented in FIG. 3, the receiving member 2 is at least partially overlapped at its free end 6 . In the present embodiment, the locking zone 4 is essentially deflected at a right angle to the rest of the bridging member 3.

The latch 5 configured as a snap closure comprises a recess 8 at the free end 6 of the receiving member 2 and an engaging member, at the locking zone 4, that can be engaged in the recess 8, in the form of a deflected tab 14, relative to the rest of the locking zone 4. The engaging member could be configured also as a stamped part, for example.

The bridging member 3 comprises an actuation element 11 arranged at its free end, which enables the user of the fastening device to open and close the latch in a convenient fashion. The actuation member 11 is deflected from the bridging member 3, for example, and extends away from the holding position of the receiving member 2, as shown, in particular, in FIGS. 3 and 5.

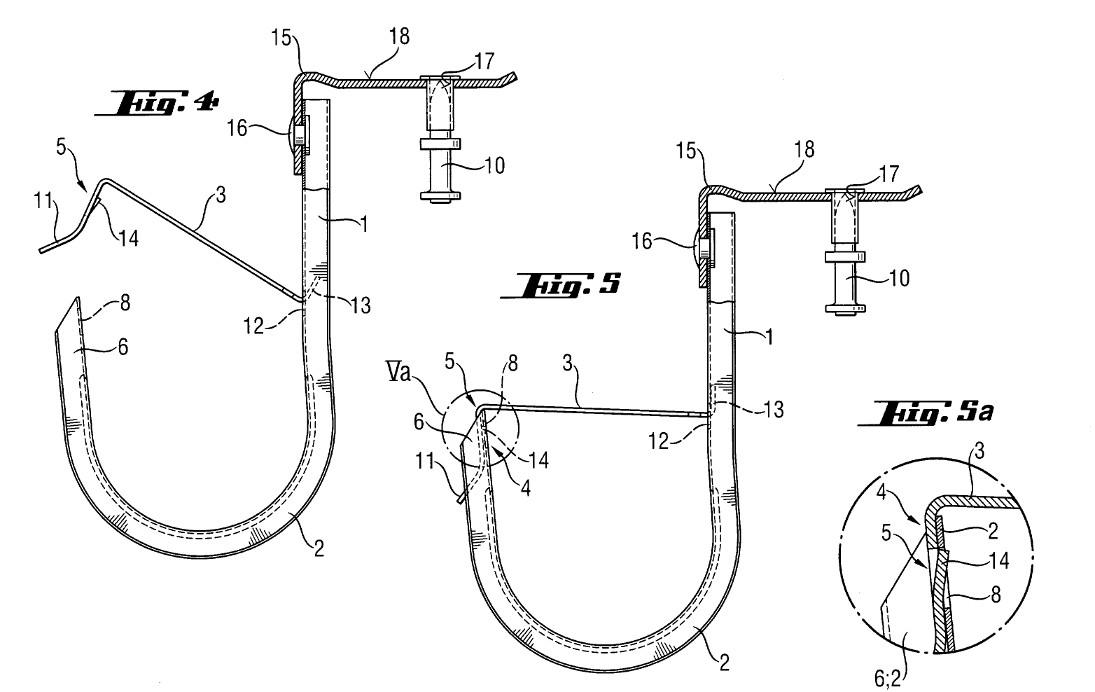

The latch 5 of the fastening device, according to the invention, can be brought into the holding position (shown in FIGS. 3 and 5) from the release position (shown in FIGS. 2 and 4) of the latch 5 by closing the latch 5. In the holding position the objects are completely encircled by the fastening device to prevent them from slipping out of the receiving member 2.

The hinged connection of the bridging member 3 and the fastening member 1, for example, comprises a recess 12 arranged on the fastening member and a hook-shaped articulation member 13 arranged on the bridging member 3 to engage the recess 12 and allow pivoting of the bridging member 3 relative to the fastening member 1. The articulation member 13 is deflected relative to the rest of the bridging member 3 and engages the fastening member 1 at least in the holding position. Preferably, the straplike bridging member 3 is die-cut from a metal sheet.

The receiving member 2 and the fastening member 1 have an essentially U-shaped crosssection and are preferably fabricated from a strip-like piece of sheet metal. The fastening member 1 has at its free end an L-shaped fastening plate 15, for example, that can be pivoted using its shorter end and connected with the rest of the fastening member by a rivet connection 16, for example. For fastening the fastening device, according to the invention, a nailing element 10 in the fastening plate 15 is lodged in a nail hole 17 using an explosive powder operated setting tool.

In the fastening process the fastening device, according to the invention, is positioned on a structural component (not shown) so that the fastening plate 15 is in contact with the surface of the structural component at a fastening surface 18. The nailing element 10 is then driven into the structural component practically perpendicular to the fastening device using the setting tool.

What is claimed is:

1. A fastening device for elongate objects comprising a fastening member (1), a hook-shaped receiving member (2) connected therewith for holding the objects and a bridging member (3) pivotingly connected with one end of the fastening member (1) that is connectable to a free end (6) of the receiving member (2) by a latch (5), wherein the bridging member (3) comprises an at least partially resilient and deflected locking zone (4).

2. The fastening device of claim 1, wherein the locking zone (4) is deflected such that, in a holding position of the latch (5), the locking zone (4) at least partially overlaps the receiving member (2) at the free end (6).

3. The fastening device of claim, wherein the locking zone (4) is deflected at practically a right angle from the rest of the bridging member (3).

4. The fastening device of claim 1, wherein the latch (5) is a snap closure.

5. The fastening device of claim 4, wherein the snap closure comprises at least one recess (8) and at least one engaging member for engaging the recess.

6. The fastening device of claim 5, wherein the engaging member is a tab (14) that is deflected relative to the rest of the locking zone (4).

7. The fastening device of claim 5, wherein the engaging member is a stamped part.

8. The fastening device of claim 1, wherein the bridging member (3) comprises an actuation member (11).

9. The fastening device of claim 8, wherein the actuation member (11) is arranged at a free end of the bridging member (3).

10. The fastening device of claim 8, wherein the actuation member (11) is deflected at an angle from the bridging member (3) and, in the holding position, extends away from the receiving member (2).
